(19) United States
(12) Patent Application Publication
(10) Pub. No.: US 2007/0084813 A1
(43) Pub. Date: Apr. 19, 2007

(54) Support device for a mobile crane

(76) Inventor: Erwin Morath, Lauterach (DE)

Correspondence Address: ALLEMAN HALL MCCOY RUSSELL & TUTTLE LLP, 806 SW BROADWAY, SUITE 600, PORTLAND, OR, 97205-3335, US

(21) Appl. No.: 11/529,957

(22) Filed: Sep. 29, 2006

(30) Foreign Application Priority Data
Oct. 4, 2005 (DE) 20 2005 015 516.0

(51) Int. Cl. B66C 23/26

(52) U.S. Cl. 212/175

(57) ABSTRACT

The present disclosure relates to a support device for a mobile crane comprising a telescopic boom which has a coupling section and at least one telescopic section which can be telescoped out of it, comprising a plurality of support frames containing outriggers which are movable in each case from a retracted transport position into an extended working position and vice versa, wherein the support device as a position detection device has at least one signal transducer in the form of an inductively acting transponder, a receiver unit for the detection of the position of the transducer, a control device for control in dependence on a signal of the receiver unit and a signal transmission device in the form of a data bus for the transmission of the signal data from the receiver unit to the control device, wherein transducers are arranged at predetermined positions on each outrigger so that the position of the support frame horizontally extensible with respect to the vehicle can be associated by the respective receiver unit.

### CROSS-REFERENCE TO RELATED APPLICATION

This application claims priority to German Utility Model Application Serial No. 20 2005 015 516.0, filed on Oct. 4, 2005, the disclosure of which is hereby incorporated by reference in its entirety for all purposes.

### FIELD

The present disclosure relates to a support device for a mobile crane comprising a telescopic boom which has a coupling section and at least one telescopic section which can be telescoped out of it, comprising a plurality of support frames containing outriggers which can be extended and which are movable in each case from a retracted transport position into an extended working position and vice versa.

### BACKGROUND AND SUMMARY

Support devices of this type for mobile cranes serve to enlarge the footprint under the crane supports. Generally, the crane undercarriage of the mobile crane is not used for support. It serves only for the transport of the crane and is suspended freely above the floor during the operation of the mobile crane. The crane is in contrast given its secure position by the wide area which results from the extended operating position of the support device.

As a rule, the support device consists of support frames which can be telescoped out and which can as a rule can be folded onto the undercarriage of the mobile crane in a transport position. They are correspondingly pivoted outwardly in their operating position and are extended in dependence on the required support and on the space conditions in the surroundings. It is important for a safe operation of the mobile crane that the support device is correctly positioned, that it is extended to the desired length, and that the outriggers are actually also supported on the ground.

It is the object of the present disclosure to further develop a support device of the initially named kind such that the reaching of the operating position of the support device can be reliably checked.

This object is solved in accordance with the present disclosure, as described below. One embodiment of a generic support device in accordance with the present disclosure has a position detection device which has at least one signal transducer in the form of an inductively acting transponder, a receiver device for the detection of the position of the transducer, a control device for control in dependence on a signal of the receiver unit and a signal transmission device in the form of a data bus for the transmission of the signal data from the receiver unit to the control device. In accordance with the present disclosure, a transducer is arranged at a predetermined position on each outrigger so that the position of the support frame horizontally extensible with respect to the vehicle can be associated by the respective receiver unit.

It can be ensured with the support device in accordance with the present disclosure that the operation of the mobile crane is only started when the support device has been extended into a correct position. The position detection device determines the position by the corresponding transponder and the associated receiver unit and transmits the respectively recorded signals to the control device of the mobile crane via the data bus. A release signal can be generated by transmission of the corresponding signal on the reaching of the desired position since this is the requirement for the activation of the telescopic boom.

Other embodiments of the present disclosure result from additional features following on from the generic support device. Accordingly, a plurality of support frames can be pushed into one another in the manner of a telescope, with at least one transponder being arranged on each support frame. It can thus automatically be accurately determined how far the respective support frame has been extended.

Furthermore, a receiver unit can be attached to the support frame into which a support frame smaller in diameter can be moved. The larger support frame thus measures the position of the support frame which can be telescoped into it or out of it.

Finally, provision is made in accordance with a further embodiment of the present disclosure for a receiver unit to be provided on that support frame on which the outrigger is extensibly arranged, said receiver unit determining the position of the vertically extensible outrigger.

A pressure switch can additionally be arranged on each outrigger via which the reaction force of the outrigger can be measured. It can therefore hereby be determined whether all outriggers are supported on the ground so that the mobile crane can operate safely.

### BRIEF DESCRIPTION OF THE FIGURES

Further features, details and advantages of the present disclosure will be explained in more detail with reference to an embodiment shown in the drawing.

FIG. 1 is a schematic perspective view of a support device in accordance with an aspect of the present disclosure;

FIG. 2 is a longitudinal section through the support device in accordance with an embodiment modified with respect to the support device shown in FIG. 1;

FIG. 3 is a schematic view of the interaction of the transponder and the receiver device of the present disclosure;

FIG. 4 is a partial sectional view in accordance with that of FIG. 2;

FIG. 5 is a perspective view of the subject of FIG. 4;

FIG. 6 is a section along the sectional line A-A in FIG. 4; and

FIG. 7 is an enlarged detail of FIG. 5.

### DETAILED DESCRIPTION

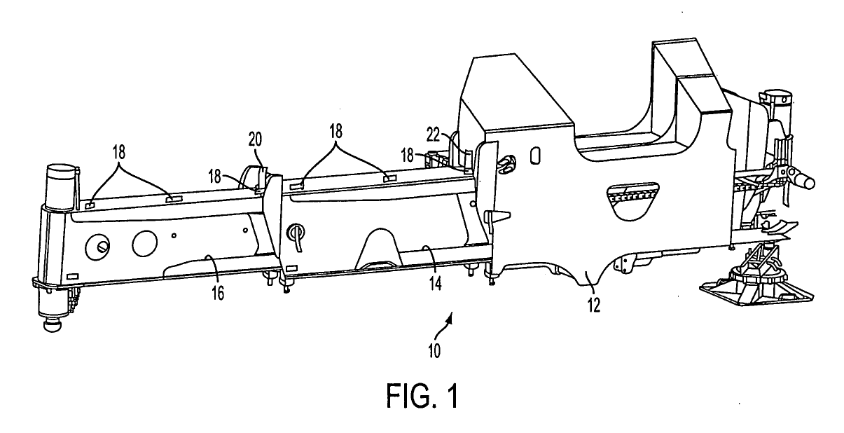

The basic structure of the support device 10 for a mobile crane not shown in any more detail here is shown in FIG. 1. The support device 10 consists of support frames 12, 14 and 16 which can be telescoped into one another. In a transport position, the frames 16 and 14 smaller in diameter are each retracted into the next larger frames 14 and 12. In this position, the support frame 12 is then folded onto the undercarriage of the mobile crane, which is not shown in the present FIG. 1. In the representation of FIG. 1, the respective support frames 12, 14 and 16 are shown in the telescoped out position.

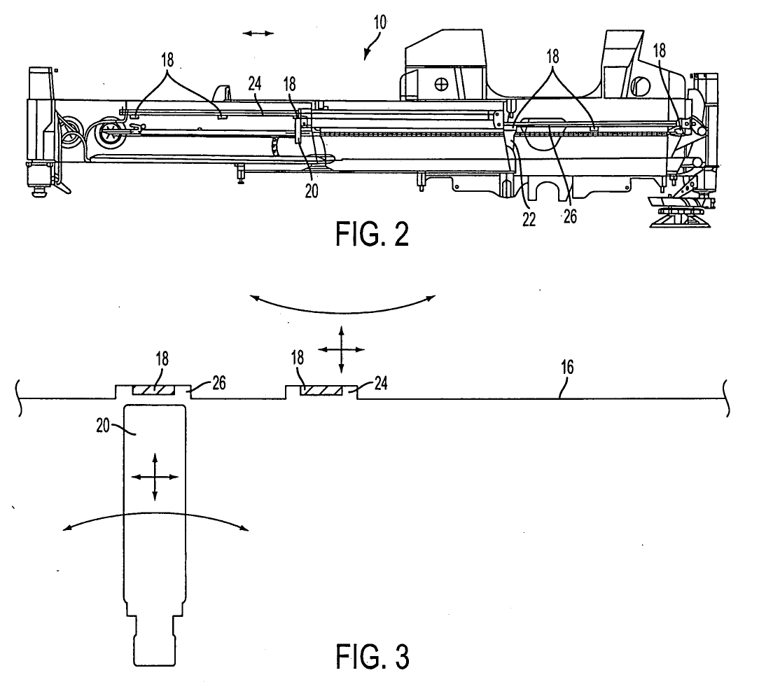

In accordance with the present disclosure, the support frames 14 and 16 now each have three signal transducers in the form of transponders 18, with these transponders 18 being arranged at uniform intervals on the support frame 14 and 16 respectively. The receiver units 20 and 22 interact with these signal transducers, with the receiver unit 20 being arranged on the support frame 14 and the receiver unit 22 being arranged on the support frame 12 in a corresponding position in each case. In the sectional representation of FIG. 2, which substantially corresponds to the embodiment of FIG. 1, the respective transponders 18 and the receiver devices are arranged in a respectively different position. They are here not arranged at the outer surface of the respective support frame 14 and 16, but on respectively telescopic bars 24 and 26.

In FIG. 3, the installation position in accordance with FIG. 1 is shown again, with here the outer surface of a support frame 16 being shown in which recesses 26 have been provided which receive the transponders 18. The receiver unit 20 is arranged opposite. Possible directions of movement of the respective elements are shown by the corresponding arrow representations.

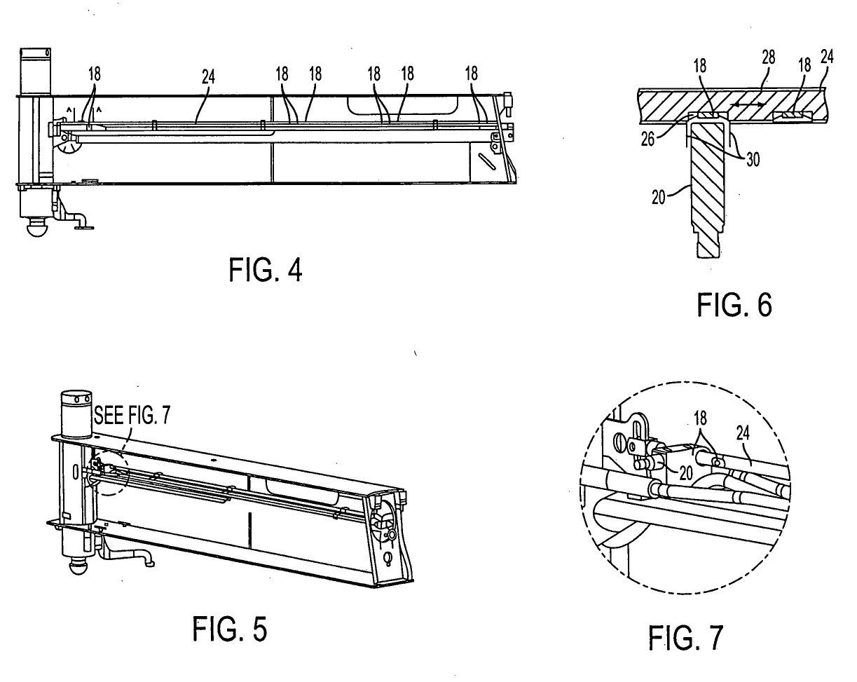

In FIGS. 4 to 7, more detailed construction details of the arrangement of the transponders on corresponding support bars 24 are shown. A series of transponders 18 is arranged along the bar 24, as results from FIG. 4.

In accordance with the sectional representation according to the section A-A, as is shown in FIG. 6, the transponders 18 are here shown in an enlarged representation, with them being inserted into corresponding recesses 26 of the bar 24. The bar 24 can be moved to and fro in the direction of the double arrow inside a guide element or shielding element 28. A reading window 30, in which the receiver device 20 is seated, is provided in the U-shaped guide element or shielding element 28. To the extent that a corresponding transponder 18 is disposed opposite the receiver device 20, as is shown in FIG. 6, the associated position is here forwarded via a signal processor, not shown in more detail here, to the control device for controlling in dependence on this signal.

In the detailed representation of FIG. 7, which represents a section of FIG. 5, the arrangement of a receiver device 20 and of the transponders 18 and of the bar 24 as a support element is shown.

1. A support device for a mobile crane comprising a telescopic boom which has a coupling section and at least one telescopic section which can be telescoped out of it, comprising a plurality of support frames containing outriggers which can be extended and which are movable in each case from a retracted transport position into an extended working position and vice versa, characterized in that the support device as a position detection device has at least one signal transducer in the form of an inductively acting transponder, a receiver unit for the detection of the position of the transducer, a control device for control in dependence on a signal of the receiver unit and a signal transmission device in the form of a data bus for the transmission of the signal data from the receiver unit to the control device, wherein transducers are arranged at predetermined positions on each outrigger so that the position of the support frame horizontally extensible with respect to the vehicle can be associated by the respective receiver unit.

2. The support device of claim 1, wherein a plurality of support frames can be pushed into one another in the manner of a telescope; and wherein at least one transponder is arranged at each support frame.

3. The support device of claim 2, wherein a receiver unit is in each case arranged on the support frame into which a support frame smaller in diameter can be moved.

4. The support device of claim 3, wherein the position of the vertically extensible outrigger can be determined by a receiver unit on the support frame on which the outrigger is extensibly arranged.

5. The support device of claim 4, wherein a pressure switch is arranged on each outrigger via which the reaction force of the outrigger can be measured.
